(19) United States
(12) Patent Application Publication
(10) Pub. No.: US 2015/0009118 A1
(43) Pub. Date: Jan. 8, 2015

(54) INTELLIGENT PAGE TURNER AND SCROLLER

(71) Applicant: Nvidia Corporation, Santa Clara, CA (US)

(72) Inventors: Jithin Thomas, Shivajinagar (IN); Darshan Uppinkere, Shivajinagar (IN)

(73) Assignee: Nvidia Corporation

(21) Appl. No.: 13/934,834

(22) Filed: Jul. 3, 2013

(51) Int. Cl. G06F 3/01

(52) U.S. Cl. CPC G06F 3/012
USPC 345/156

(57) ABSTRACT

Provided is a method for changing an image on a display. The method, in one embodiment, includes providing a first image on a display. The method, in this embodiment, further includes tracking a movement of a user's facial feature as it relates to the first image on the display, and generating a command to provide a second different image on the display based upon the tracking.

### TECHNICAL FIELD

This application is directed, in general, to image display and, more specifically, to an intelligent page turner and scroller, and an electronic device for accomplishing the same.

### BACKGROUND

Computers of all types and sizes, including desktop computers, laptop computers, tablets, smart phones, etc., embody one technique or another to turn pages and/or scroll about a page. For example, traditional desktop computers typically use a mouse (e.g., wired or wireless) to turn pages and/or scroll about a page. Alternatively, traditional laptop computers typically use a mouse pad to turn pages and/or scroll about a page. Certain tablets and smart phones, on the other hand, may use swipes of the user's fingers over the display screen to turn pages and/or scroll about a page. What is needed is an improved method for turning pages and/or scrolling about a page, as well as an electronic device for accomplishing the same.

### SUMMARY

One aspect provides a method for changing an image on a display. The method, in one embodiment, includes providing a first image on a display. The method, in this aspect, further includes tracking a movement of a user's facial feature as it relates to the first image on the display, and generating a command to provide a second different image on the display based upon the tracking.

Another aspect provides an electronic device. The electronic device, in this aspect, includes a display having a face detection sensor associated therewith, and storage and processing circuitry associated with the display and the face detection sensor. The storage and processing circuitry, in this embodiment, is operable to 1) provide a first image on the display, 2) track a movement of a user's facial feature as it relates to the first image on the display, and 3) generate a command to provide a second different image on the display based upon the tracking.

### BRIEF DESCRIPTION

Reference is now made to the following descriptions taken in conjunction with the accompanying drawings, in which:

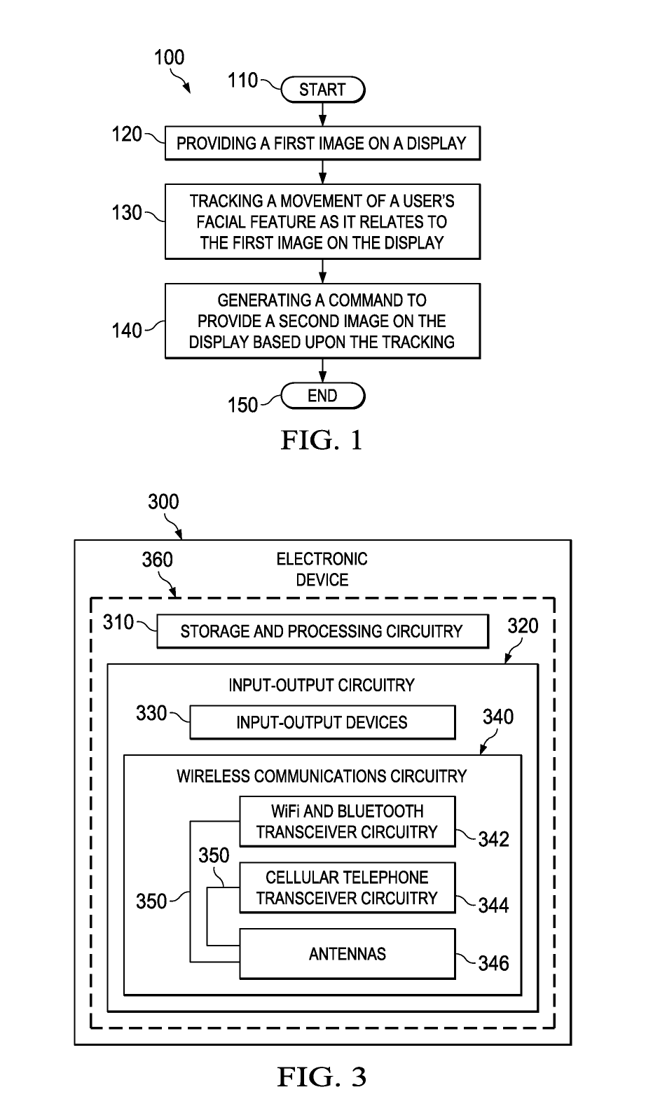

FIG. 1 a flow diagram of one embodiment of a method for changing an image on a display;

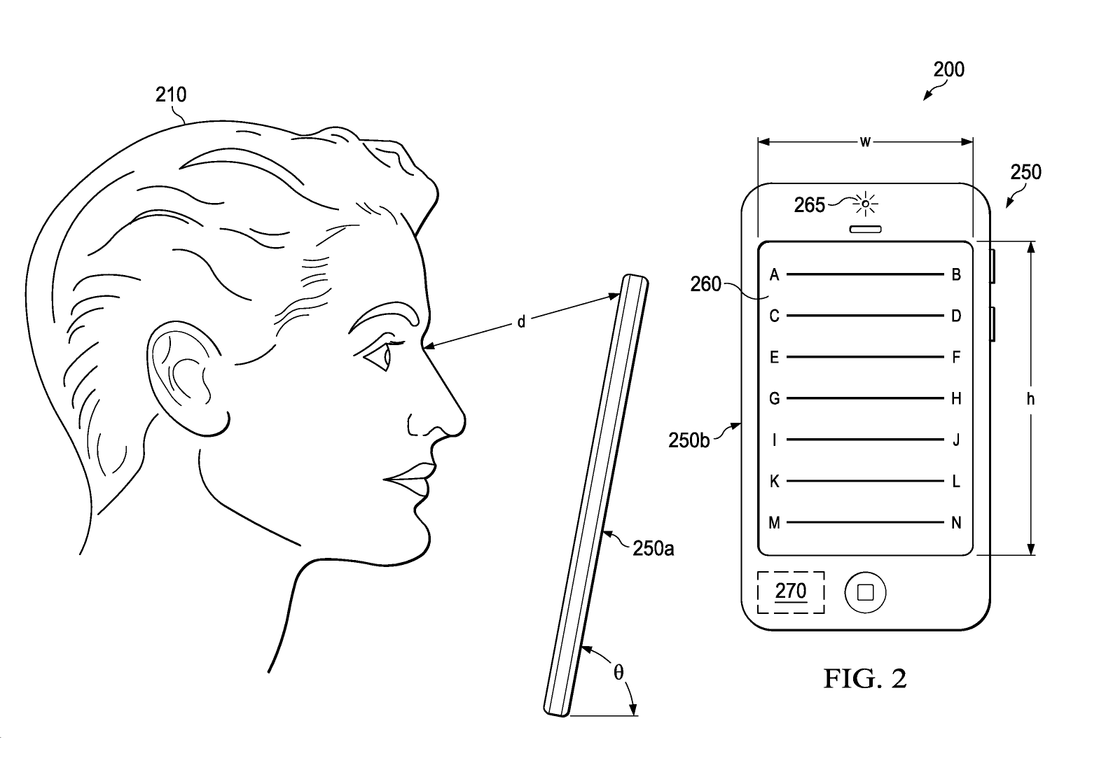

FIG. 2 illustrates a scenario wherein a user is viewing an electronic device;

FIG. 3 illustrates a schematic diagram of electronic device manufactured in accordance with the disclosure; and

FIGS. 4-6 illustrate alternative aspects of a representative embodiment of an electronic device in accordance with embodiments of the disclosure;

### DETAILED DESCRIPTION

The present disclosure is based, at least in part, on the acknowledgement that traditional methods for changing a page in an electronic book (e-book) or scrolling within an electronic document (e-document) are unnatural. The present disclosure has further acknowledged that such methods hinder users with certain physical handicaps from enjoying the experience of e-books and documents.

The present disclosure is further based, at least in part, on the acknowledgement that as a user typically reads on an electronic device, the user's facial features move from left to right and top to bottom. This movement is typically directly proportional to the size of the display (e.g., height (h) and width (w)) and inversely proportional to the distance (d) of the individual's facial feature to the display. The movement also typically depends on the relative angle (θ) of the display relative to the user's facial feature.

With these acknowledgments in mind, the present disclosure has recognized that a face detection sensor can be associated with a display to track a movement of a user's facial feature(s) as it relates to the image being displayed. Accordingly, at the appropriate time, a command can be generated to change or scroll within the page. Ultimately, by tracking the gaze of a user's eye(s) using the face detection sensor, the display can be prompted to change or scroll within the page of an e-document.

In one embodiment, this is accomplished by determining a distance (d) of the display to the user's eyes, and the angle (θ) at which the display is held relative to the user's eyes. With this knowledge, as well as the known height (h) and width (w) of the display, the face detection sensor can detect the position of the user's eyes as he/she starts viewing (e.g., reading) the image. Thereafter, the face detection sensor can track the gaze of the user's eyes, and when it reaches a predefined location (e.g., the bottom-right corner of the display), generate a command to change or scroll within the page of the e-document. Accordingly, the present disclosure has the benefits of being able to change or scroll within the page of an e-document using a user's facial features, particularly a user's eyes, without the user having to do anything with his/her hands.

The present disclosure has further recognized that the ability to move within e-documents is not limited to changing the page of an e-book. For example, the recognitions of the present disclosure can also be applied to scroll (e.g., right, left, up or down) within any e-document. For example, the recognitions of the present disclosure are applicable to general web browsing, scrolling through lists in an application, navigating through different screens on a device, etc.

FIG. 1 is a flow diagram 100 of one embodiment of a method for changing an image on a display. The method for changing an image on a display begins in a start step 110 and continues on to step 120 wherein a first image is provided on a display. The term “image” as it is used throughout this disclosure is intended to refer to what is being displayed on the screen, as opposed to a picture. The image need not only be a picture (e.g., JPEG image, TIFF image, GIF image, etc.), but can be a word processing image, a web browsing image, an application image, a screen image, etc. Once the content of a given image changes in any way, it is no longer the same image, but is a different image. As an example, when one changes from one page to another in an e-book, there is a change from a first image to a second different image. Similarly, as one scrolls up or down within a web page, there is a change from a first image to a second different image—even if the scroll is just a single line of text that was otherwise not shown in the first image. The same goes for a change of lists, and so on and so forth.

In a step 130, a movement of a user's facial feature is tracked as it relates to the first image on the display. In accordance with this disclosure, the tracking of the user's facial feature may be the tracking of one or more eyes of a user. For example, a face detection sensor with an associated face detection algorithm might be used to track a lateral or vertical movement of the user's eyes. In another embodiment, the face detection sensor tracks movement of the user's eyes as they gaze from left to right and up to down on the display, such as might occur when reading an e-document. In an alternative embodiment, the face detection sensor might track movement of the user's eyes as they gaze from right to left, and even down to up, such as might occur when reading an e-document in certain other foreign countries. Ultimately, the face detection sensor and associated face detection algorithm are operable to detect when a user has finished reading a particular image, such as when the user's gaze reached the bottom right hand corner of the document—at least when configured for English and other related users.

As discussed above, in one embodiment the face detection sensor and associated face detection algorithm use dimensions (e.g., width (w) and height (h)) of the display to track the movement of the user's eyes. Typically, the dimensions of the display are a known value for the face detection algorithm. In other embodiments, such as wherein the face detection feature is an after market add-on feature, the dimensions of the display might need to be provided to the face detection algorithm.

As further discussed above, in one embodiment the face detection sensor and associated face detection algorithm use a distance (d) and angle (θ) between the user's facial feature and the display, to track the movement. The distance (d) and angle (θ) will likely constantly change based upon the size of the display and particular user. Accordingly, in one embodiment, the face detection sensor and associated face detection algorithm are capable of measuring the distance (d) and angle (θ). For instance, the face detection sensor and associated algorithm could have an embedded proximity sensor and angle sensor associated therewith. Likewise, the face detection sensor, proximity sensor and related algorithms could be associated with a digital camera, as is typically made part of many electronic devices.

Having tracked the movement of the user's facial feature (e.g., eyes in one embodiment), a command is generated in a step 140 to provide a second different image on the display. As discussed above, the command could include changing a page in an e-book. The changing of page could be similar to what someone would do in a physical (e.g., non electronic) book, such as from right to left. Certain instances of the changing of the page might also occur from down to up, and vice-versa.

In another embodiment, the command could include causing the e-document to scroll down. For instance, if the user were reading a word processing document, the command could be to scroll down within the e-document. The scrolling, in this embodiment, need not scroll to an entirely different page, but could be scrolling one or more new lines of information onto the display. As discussed above, even this little change in the text is considered a change in the image from the first image to the second different image.

In accordance with the disclosure, the step 140 of generating a command to provide a second different image on the display can be enabled or disenabled by the user of the device. For example, certain situations may exist wherein the user of the device desires to disenable this feature. Accordingly, the user could readily disenable the feature by clicking a button, going into a setup screen, or any other known or hereafter discovered process.

In accordance with the disclosure, each of the steps 120, 130, 140, at least in one embodiment, may be user configurable. For example, the user of the device could configure the tracking step 130 to be operable for an English speaking/reading individual. Alternatively, the user of the device could configure the tracking step 130 to be operable for a Chinese speaking/reading individual, among others, that might not read from top to bottom and left to right. Additionally, step 140 could be user configured such that it generates the command to change to the second different picture only after a designated period of time has elapsed. A multitude of different features could be user configured in accordance with the principles of the present disclosure.

In one embodiment, each of the steps 120, 130, 140 occur at substantially real-time speeds. The phrase “substantially real-time speeds”, as used herein, means the process of steps 120, 130, 140 can be timely used for reading e-documents and/or e-books. In those scenarios wherein a lag occurs that substantially impedes the reading of the e-documents and/or e-books, steps 120, 130 and 140 are not occurring at substantially real-time speeds. The method for displaying an image would conclude in an end step 150.

Heretofore the present disclosure, the disclosed method was unrealistic to achieve. Specifically, the present disclosure benefits from a multitude of factors that have only recently (e.g., as a whole) been accessible. For example, only recently has image processing software been readily accessible to accomplish the desires stated above, for example in real-time. Additionally, only recently have electronic devices, particularly mobile electronic devices, had the capability to run the image processing software, for example in substantially real-time speeds. Likewise, face detection sensors and proximity sensors have only recently reduced in price to a level that it is economical, and thus feasible, to associate them with a display, or in the case of mobile electronic devices, within the housing along with the display.

FIG. 2 illustrates a scenario 200, wherein a user 210 is viewing an electronic device 250. The electronic device 250, in the scenario of FIG. 2, is depicted from a side view 250a (as the user 210 would be viewing the electronic device 250) as well as a frontal view 250b (as if the reader of this document were viewing the electronic device 250). The electronic device 250 may comprise a variety of different electronic devices and remain within the purview of the disclosure. In one embodiment, the electronic device 250 is a portable electronic device, such as a smartphone, a tablet computer, a handheld computer, an e-book reader, a laptop computer, gaming system, etc. Such portable electronic devices might include wireless mobile communication technologies, among other communication technologies. In another embodiment, the electronic device 250 is a desktop computer, a television, or a projector, among others. In essence, the electronic device 250 could be any device with a display that is operable to show e-documents.

With the foregoing being said, the electronic device 250 illustrated in FIG. 2 is a smartphone or tablet device. For example, the electronic device 250 is illustrated as an IPhone or IPad in FIG. 2. Nevertheless, other smartphones or tablet devices (among other electronic devices) are within the scope of the present disclosure.

In accordance with one embodiment of the disclosure, the electronic device 250 includes a display 260. The display 260 may be any currently known or hereafter discovered display, and remain within the purview of the present disclosure. Nevertheless, in the embodiment shown the display 260 is a LCD display.

The display 260, in accordance with one embodiment, includes a face detection sensor 265 associated therewith. The face detection sensor 265, in one embodiment, may function as a proximity sensor. In another embodiment, the proximity sensor is a dedicated device. The face detection sensor 265, and the proximity sensor if presented as a dedicated device, may be associated with a digital camera of the electronic device 250. Accordingly, certain embodiments may exist wherein the electronic device 250 includes a single device feature that provides photography, face detection, and proximity sensing functions, among others.

In one embodiment, such as the embodiment of FIG. 2 wherein the electronic device 250 is a portable electronic communications device, the face detection sensor 265 is integral to the display 260. For instance, the face detection sensor 265 might be positioned directly above or below an image display portion of the display 260. In other embodiments, such as those shown in subsequent FIGS., the face detection sensor 265 is associated with the display 260, and thus need not form an integral portion of the display 260 and/or electronic device 250.

The electronic device 250 of FIG. 2 may further include storage and processing circuitry 270. The storage and processing circuitry 270, in the embodiment of FIG. 2, is associated with the display 260 and the face detection sensor 265. The storage and processing circuitry 270, in this embodiment, is operable to change an image on a display, as was discussed above with regard to FIG. 1.

The storage and processing circuitry 270, in accordance with the disclosure, is operable to provide a first image on the display 260. With the first image shown on the display, the storage and processing circuitry 270, in one embodiment, is operable to track lateral or vertical movement of the user's facial feature (e.g., using the face detection sensor 265). For example, the storage and processing circuitry 270 might track the movement of the user's facial feature (e.g., eyes in one embodiment) from left to right and up to down as the user gazes at an e-document shown on the display 260.

The storage and processing circuitry 270, in accordance with one embodiment of the disclosure, is operable to employ dimensions of the display 260 to track the movement of the user's 210 facial feature. For example, the storage and processing circuitry 270 might use the width (w) and height (h) of the display 260 to track the movement of the user's 210 facial features. Similarly, the storage and processing circuitry 270 might use the distance (d) between the display 260 and the user 210, as well as the relative angle (θ) of the display 260 relative to the user's 210 facial feature. In one embodiment, the storage and processing circuitry 270, along with the face detection sensor 265, is operable to calculate the distance (d) and relative angle (θ). Those skilled in the art understand the information and steps required to track a user's facial feature as it relates to an image on a display, given that already known in the art and that disclosed herein.

With reference to the electronic device 250b, the storage and processing circuitry 270 might track the user's 210 eyes as they move from point A to point B, back to point C and then to point D, and so on, until the user's eyes reach point N. At this moment, based upon the tracking and an understanding that the user has reached the end of the e-document, the storage and processing circuitry 270 might generate a command to provide a second different image on the display 260. As indicated above, providing a second different image might be changing the page of an e-book, or just scrolling up or down within and e-document, among others.

FIG. 3 shows a schematic diagram of electronic device 300 manufactured in accordance with the disclosure. Electronic device 300 may be a portable device such as a mobile telephone, a mobile telephone with media player capabilities, a handheld computer, a remote control, a game player, a global positioning system (GPS) device, a laptop computer, a tablet computer, an ultraportable computer, a combination of such devices, or any other suitable portable electronic device. Electronic device 300 may additionally be a desktop computer, television, or projector system, among others.

As shown in FIG. 3, electronic device 300 may include storage and processing circuitry 310. Storage and processing circuitry 310 may include one or more different types of storage such as hard disk drive storage, nonvolatile memory (e.g., flash memory or other electrically-programmable-read-only memory), volatile memory (e.g., static or dynamic random-access-memory), etc. The processing circuitry may be used to control the operation of device 300. The processing circuitry may be based on a processor such as a microprocessor and other suitable integrated circuits. With one suitable arrangement, storage and processing circuitry 310 may be used to run software on device 300, such as face detection algorithms, etc., as might have been discussed above with regard to previous FIGS. The storage and processing circuitry 310 may, in another suitable arrangement, be used to run internet browsing applications, voice-over-internet-protocol (VOIP) telephone call applications, email applications, media playback applications, operating system functions, etc. Storage and processing circuitry 310 may be used in implementing suitable communications protocols.

Communications protocols that may be implemented using storage and processing circuitry 310 include, without limitation, internet protocols, wireless local area network protocols (e.g., IEEE 802.11 protocols—sometimes referred to as WiFi®), protocols for other short-range wireless communications links such as the Bluetooth® protocol, protocols for handling 3G communications services (e.g., using wide band code division multiple access techniques), 2G cellular telephone communications protocols, etc. Storage and processing circuitry 310 may implement protocols to communicate using cellular telephone bands at 850 MHz, 900 MHz, 1800 MHz, and 1900 MHz (e.g., the main Global System for Mobile Communications or GSM cellular telephone bands) and may implement protocols for handling 3G and 4G communications services.

Input-output device circuitry 320 may be used to allow data to be supplied to device 300 and to allow data to be provided from device 300 to external devices. Input-output devices 330 such as touch screens and other user input interfaces are examples of input-output circuitry 320. Input-output devices 330 may also include user input-output devices such as buttons, joysticks, click wheels, scrolling wheels, touch pads, key pads, keyboards, microphones, cameras, etc. A user can control the operation of device 300 by supplying commands through such user input devices. Display and audio devices may be included in devices 330 such as liquid-crystal display (LCD) screens, light-emitting diodes (LEDs), organic light-emitting diodes (OLEDs), and other components that present visual information and status data. Display and audio components in input-output devices 330 may also include the aforementioned face detection sensor, a proximity sensor, as well as audio equipment such as speakers and other devices for creating sound. If desired, input-output devices 330 may contain audio-video interface equipment such as jacks and other connectors for external headphones and monitors.

Wireless communications circuitry 340 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications). Wireless communications circuitry 340 may include radio-frequency transceiver circuits for handling multiple radio-frequency communications bands. For example, circuitry 340 may include transceiver circuitry 342 that handles 2.4 GHz and 5 GHz bands for WiFi® (IEEE 802.11) communications and the 2.4 GHz Bluetooth® communications band. Circuitry 340 may also include cellular telephone transceiver circuitry 344 for handling wireless communications in cellular telephone bands such as the GSM bands at 850 MHz, 900 MHz, 1800 MHz, and 1900 MHz, as well as the UMTS and LTE bands (as examples). Wireless communications circuitry 340 can include circuitry for other short-range and long-range wireless links if desired. For example, wireless communications circuitry 340 may include global positioning system (GPS) receiver equipment, wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 340 may include one or more antennas 346. Device 300 may be provided with any suitable number of antennas. There may be, for example, one antenna, two antennas, three antennas, or more than three antennas in device 300. In accordance with that discussed above, the antennas may handle communications over multiple communications bands. If desired, a dual band antenna may be used to cover two bands (e.g., 2.4 GHz and 5 GHz). Different types of antennas may be used for different bands and combinations of bands. For example, it may be desirable to form an antenna for forming a local wireless link antenna, an antenna for handling cellular telephone communications bands, and a single band antenna for forming a global positioning system antenna (as examples).

Paths 350, such as transmission line paths, may be used to convey radio-frequency signals between transceivers 342 and 344, and antenna 346. Radio-frequency transceivers such as radio-frequency transceivers 342 and 344 may be implemented using one or more integrated circuits and associated components (e.g., power amplifiers, switching circuits, matching network components such as discrete inductors, capacitors, and resistors, and integrated circuit filter networks, etc.). These devices may be mounted on any suitable mounting structures. With one suitable arrangement, transceiver integrated circuits may be mounted on a printed circuit board. Paths 350 may be used to interconnect the transceiver integrated circuits and other components on the printed circuit board with antenna structures in device 300. Paths 350 may include any suitable conductive pathways over which radio-frequency signals may be conveyed including transmission line path structures such as coaxial cables, microstrip transmission lines, etc.

The device 300 of FIG. 3 further includes a chassis 360. The chassis 360 may be used for mounting/supporting electronic components such as a battery, printed circuit boards containing integrated circuits and other electrical devices, etc. For example, in one embodiment, the chassis 360 positions and supports the storage and processing circuitry 310, and the input-output circuitry 320, including the input-output devices 330 and the wireless communications circuitry 340 (e.g., including the WIFI and Bluetooth transceiver circuitry 342, the cellular telephone circuitry 344, and the antennas 346).

The chassis 360 may be made of various different materials, including metals such as aluminum. The chassis 360 may be machined or cast out of a single piece of material. Other methods, however, may additionally be used to form the chassis 360.

FIG. 4 illustrates alternative aspects of a representative embodiment of an electronic device 400 in accordance with embodiments of the disclosure. The electronic device 400 of FIG. 4 is configured as a laptop computer. The electronic device 400 includes many of the features of the electronic device 200 of FIG. 2, including a display 410 having a face detection sensor 420 associated therewith. The electronic device 400, similar to the electronic device 200, further includes storage and processing circuitry 440. The storage and processing circuitry 440, in accordance with this disclosure, is operable to accomplish the method discussed above with regard to FIGS. 1 and 2.

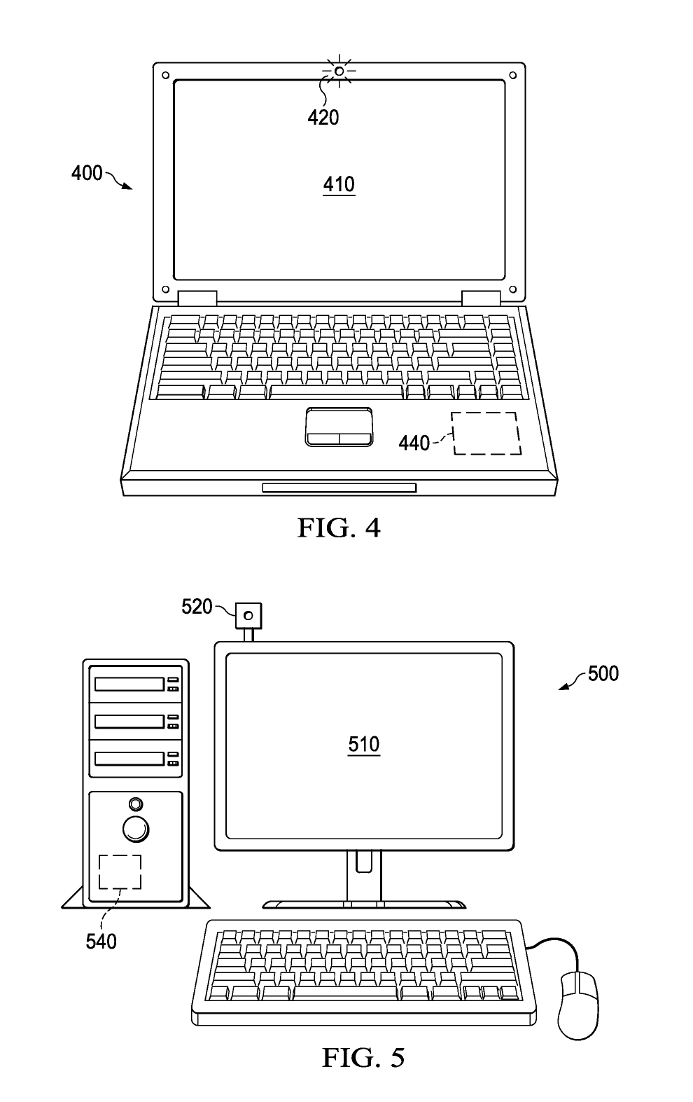

FIG. 5 illustrates alternative aspects of a representative embodiment of an electronic device 500 in accordance with embodiments of the disclosure. The electronic device 500 of FIG. 5 is configured as a desktop computer. The electronic device 500 includes many of the features of the electronic device 200 of FIG. 2, including a display 510 having a face detection sensor 520 associated therewith. The face detection sensor 520, in this embodiment, is attached to (e.g., as opposed to integral to) the display 510. The electronic device 500, similar to the electronic device 200, further includes storage and processing circuitry 540. The storage and processing circuitry 540, in accordance with this disclosure, is operable to accomplish the method discussed above with regard to FIGS. 1 and 2.

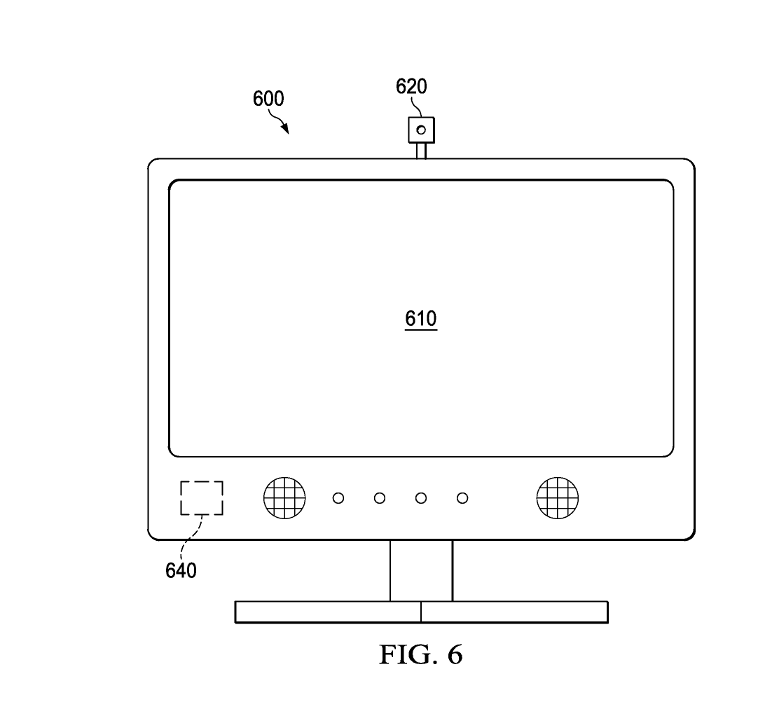

FIG. 6 illustrates alternative aspects of a representative embodiment of an electronic device 600 in accordance with embodiments of the disclosure. The electronic device 600 of FIG. 6 is configured as a television. The electronic device 600 includes many of the features of the electronic device 200 of FIG. 2, including a display 610 having a face detection sensor 620 associated therewith. The face detection sensor 620, in this embodiment, is attached to (e.g., as opposed to integral to) the display 610. The electronic device 600, similar to the electronic device 200, further includes storage and processing circuitry 640. The storage and processing circuitry 640, in accordance with this disclosure, is operable to accomplish the method discussed above with regard to FIGS. 1 and 2. While the embodiment of FIG.6 is illustrated as a television, those skilled in the art understand that a face detection sensor could be associated with projection systems (e.g., both front and rear projection systems) and remain within the purview of the disclosure.

Those skilled in the art to which this application relates will appreciate that other and further additions, deletions, substitutions and modifications may be made to the described embodiments.

What is claimed is:

1. A method for changing an image on a display, comprising:
providing a first image on a display;
tracking a movement of a user's facial feature as it relates to the first image on the display; and
generating a command to provide a second different image on the display based upon the tracking.

2. The method of claim 1, wherein tracking includes tracking a lateral or vertical movement of the user's facial feature.

3. The method of claim 2, wherein tracking includes tracking the movement of the user's facial feature from left to right and up to down.

4. The method of claim 1, wherein tracking the movement of the user's facial feature includes tracking the movement of one or more eyes of the user.

5. The method of claim 1, wherein tracking the movement of the user's facial feature as it relates to the first image on the display includes tracking the movement of the user's facial feature using dimensions of the display.

6. The method of claim 5, wherein tracking the movement of the user's facial feature as it relates to the first image on the display includes tracking the movement of the user's facial feature using a distance and angle between the user's facial feature and the display.

7. The method of claim 1, wherein tracking the movement of the user's facial feature includes tracking the movement of the user's facial feature using a face detection algorithm.

8. The method of claim 1, wherein generating the command to provide the second image includes changing a page in an e-book.

9. The method of claim 1, wherein generating the command to provide the second image includes scrolling up or down in an electronic document.

10. The method of claim 1, wherein generating the command to provide the second image on the display based upon the tracking is user engageable/disengageable.

11. An electronic device, comprising:
a display having a face detection sensor associated therewith; and
storage and processing circuitry associated with the display and the face detection sensor, the storage and processing circuitry operable to:
provide a first image on the display;
track a movement of a user's facial feature as it relates to the first image on the display; and
generate a command to provide a second different image on the display based upon the tracking.

12. The electronic device of claim 11, wherein the storage and processing circuitry is operable to track a lateral or vertical movement of the user's facial feature.

13. The electronic device of claim 12, wherein the storage and processing circuitry is operable to track the movement of the user's facial feature from left to right and up to down.

14. The electronic device of claim 11, wherein the storage and processing circuitry is operable to track the movement of one or more eyes of the user.

15. The electronic device of claim 11, wherein the storage and processing circuitry is operable to employ dimensions of the display to track the movement of the user's facial feature.

16. The electronic device of claim 15, wherein the storage and processing circuitry is operable to detect a distance and angle between the user's feature and the display to track the movement of the user's facial feature.

17. The electronic device of claim 11, wherein the storage and processing circuitry is operable to track the movement of the user's facial feature using the face detection sensor.

18. The electronic device of claim 11, wherein the storage and processing circuitry is operable to change a page in an e-book or scroll up or down in an electronic document.

19. The electronic device of claim 11, wherein the face detection sensor is integral to the display.

20. The electronic device of claim 11, wherein the display, face detection sensor and storage and processing circuitry form a portion of a device selected from the group consisting of:
a desktop computer;
a laptop computer;
a tablet computer;
handheld computer;
a smartphone;
a television; and
a projector.
